(19) United States
(12) Patent Application Publication
(10) Pub. No.: US 2022/0066770 A1
(43) Pub. Date: Mar. 3, 2022

(54) DEVICE AND METHOD FOR MANAGING UPDATE OF ECU OF VEHICLE

(71) Applicants: HYUNDAI MOTOR COMPANY, Seoul (KR); Kia Corporation, Seoul (KR)

(72) Inventors: Hyeok Sang JEONG, Gunpo-si (KR); Yoon Sik JUNG, Seoul (KR); Jae Hoon LEE, Seoul (KR); Myeong Gyu JEONG, Seoul (KR)

(73) Assignees: HYUNDAI MOTOR COMPANY, Seoul (KR); Kia Corporation, Seoul (KR)

(21) Appl. No.: 17/462,708

(22) Filed: Aug. 31, 2021

(30) Foreign Application Priority Data
Aug. 31, 2020 (KR) 10-2020-0110485

(51) Int. Cl. G06F 8/65; B60W 50/00; G07C 5/08

(52) U.S. Cl. CPC G06F 8/65; B60W 50/0098; B60W 2050/0083; G07C 5/085; G07C 5/0825

(57) ABSTRACT

A device for managing an update of an electronic control unit (ECU) of a vehicle includes storage that stores an update table, wherein an ID and version information of software corresponding to each of the plurality of ECUs of the vehicle are recorded for each version of the software in the update table; a communication device that receives the ID and the version information of the software installed in each of the plurality of ECUs; and a controller that manages an update for each of the plurality of ECUs based on the update table having the ID and the version information of the software installed in each of the plurality of ECUs.

### CROSS-REFERENCE TO RELATED APPLICATION

This application claims the benefit of priority to Korean Patent Application No. 10-2020-0110485, filed in the Korean Intellectual Property Office on Aug. 31, 2020, the entire contents of which are incorporated herein by reference.

### TECHNICAL FIELD

The present disclosure relates to a technology for managing a firmware update of each electronic control unit included in a vehicle.

### BACKGROUND

As electronization of parts for a vehicle proceeds at a high speed, types and the number of electronic devices mounted on the vehicle are greatly increased. The electronic device may be used roughly in a power train control system, a body control system, a chassis control system, a vehicle network, a multimedia system, and the like. The power train control system may include an engine control system, an automatic shift control system, and the like. The body control system may include a body electronic product control system, a convenience device control system, a lamp control system, and the like. The chassis control system may include a steering device control system, a brake control system, a suspension control system, and the like. The vehicle network may include a controller area network (CAN), a FlexRay-based network, a media oriented systems transport (MOST)-based network, and the like. The multimedia system may include a navigation device system, a telematics system, an infotainment system, and the like.

Such systems and electronic devices constituting each of the systems are connected to each other through the vehicle network, and the vehicle network for supporting a function of each of the electronic devices is being required. The CAN may support a transmission speed of up to 1 Mbps, and may support automatic retransmission of a collided frame, cycle redundancy check (CRC)-based error detection, and the like. The FlexRay-based network may support a transmission speed of up to 10 Mbps, and may support simultaneous transmission of data through two channels, data transmission in a synchronization scheme, and the like. The MOST-based network, which is a communication network for high-quality multimedia, may support a transmission speed of up to 150 Mbps.

In one example, the telematics system, the infotainment system, an improved safety system, and the like of the vehicle require a high transmission speed, system scalability, and the like, but the CAN, the FlexRay-based network, and the like are not able to fully support those. The MOST-based network is able to support a higher transmission speed compared to the CAN and the FlexRay-based network, but a lot of cost is consumed to apply the MOST-based network to all networks of the vehicle. Because of such problems, an Ethernet-based network may be considered as the vehicle network. The Ethernet-based network is able to support bidirectional communication through a pair of wires, and is able to support a transmission speed of up to 10 Gbps.

Each of the electronic devices connected to each other through the vehicle network as such has an electronic control unit (ECU), and at least one software is installed in each ECU, so that the number of software installed in each ECU included in the vehicle ranges from dozens to hundreds. Thus, there is a need for a method for managing updates for the software.

The matters described in this background are written to enhance an understanding of the background of the invention, and may include matters other than the prior art already known to those of ordinary skill in the field to which this technology belongs.

### SUMMARY

The present disclosure has been made to solve the above-mentioned problems occurring in the prior art while advantages achieved by the prior art are maintained intact.

An aspect of the present disclosure provides a device and a method for managing an update of an ECU of a vehicle that enable batch updates of electronic control units (ECUs) included in the vehicle by including an update table in which an ID and version information of software corresponding to each ECU of the vehicle are recorded for each version of the vehicle, and managing an update for each ECU of the vehicle based on the update table.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, a device for managing an update of an electronic control unit (ECU) of a vehicle includes: storage that stores an update table, wherein an identification (ID) and version information of software corresponding to each of the plurality of ECUs of the vehicle are recorded for each version of the vehicle in the update table; a communication device that receives the ID and the version information of the software installed in each of the plurality of ECUs of the vehicle; and a controller that manages an update for each of the plurality of ECUs based on the update table having the ID and the version information of the software installed in each of the plurality of ECUs.

In one implementation, the controller may divide the versions of the vehicle into a lower version group and a higher version group, and determine that version up to a lowest version in the higher version group is possible when all of the version information of the software installed in each ECU is included in the lower version group.

In one implementation, the controller may transmit update data corresponding to the lowest version in the higher version group to an ECU update control device.

In one implementation, the controller may divide the versions of the vehicle into a lower version group and a higher version group, and determine that the update is impossible when not all of the version information of the software installed in each ECU is included in the lower version group.

In one implementation, the controller may inform an ECU update control device of the determination that the update is impossible.

In one implementation, the update table may include a plurality of fields where the versions of the vehicle are sequentially recorded, and a plurality of fields where the version information of each software of each ECU is recorded corresponding to each of the plurality of fields where the versions of the vehicle are sequentially recorded.

According to another aspect of the present disclosure, a method for managing an update of an ECU of a vehicle includes storing, by storage, an update table, wherein an ID and version information of software corresponding to each electronic control unit (ECU) of the vehicle are recorded for each version of the vehicle in the update table, receiving, by a communication device, the ID and the version information of the software installed in each ECU of the vehicle, and managing, by a controller, an update for each ECU of the vehicle based on the update table, the ID and the version information of the software installed in each ECU.

In one implementation, the method may include dividing the versions of the vehicle into a lower version group and a higher version group, and determining that version up to a lowest version in the higher version group is possible when all of the version information of the software installed in each ECU is included in the lower version group.

In one implementation, the method may further include transmitting update data corresponding to the lowest version in the higher version group to an ECU update control device.

In one implementation, the method may include dividing the versions of the vehicle into a lower version group and a higher version group, and determining that the update is impossible when not all of the version information of the software installed in each ECU is included in the lower version group.

In one implementation, the method may further include informing an ECU update control device of the determination that the update is impossible.

According to another aspect of the present disclosure, a system for managing an update of an ECU of a vehicle includes an ECU update management device that stores an update table, wherein an ID and version information of software corresponding to each electronic control unit (ECU) of the vehicle are recorded for each version of the vehicle in the update table, receives the ID and the version information of the software installed in each ECU of the vehicle, and manages an update for each ECU of the vehicle based on the update table, the ID and the version information of the software installed in each ECU, and an ECU update control device that transmits the ID and the version information of the software installed in each ECU of the vehicle to the ECU update management device, and controls the update of each ECU of the vehicle in association with the ECU update management device.

In one implementation, the ECU update management device may divide the versions of the vehicle into a lower version group and a higher version group, and determine that version up to a lowest version in the higher version group is possible when all of the version information of the software installed in each ECU is included in the lower version group.

In one implementation, the ECU update management device may transmit update data corresponding to the lowest version in the higher version group to the ECU update control device.

In one implementation, the ECU update control device may perform roll back of returning a version of an ECU that has already been updated to a previous version in the process of controlling the update of each ECU of the vehicle when an update of one ECU has failed.

In one implementation, the ECU update management device may divide the versions of the vehicle into a lower version group and a higher version group, and determine that the update is impossible when not all of the version information of the software installed in each ECU is included in the lower version group.

In one implementation, the ECU update management device may inform the ECU update control device of the determination that the update is impossible.

In one implementation, the ECU update control device may display a breakdown code when it is determined by the ECU update management device that the update is impossible, and provide guidance information on a breakdown to a user.

### BRIEF DESCRIPTION OF THE DRAWINGS

The above and other objects, features and advantages of the present disclosure will be more apparent from the following detailed description taken in conjunction with the accompanying drawings:

FIG. 1 is an exemplary diagram of a system for managing an update of an ECU of a vehicle according to an embodiment of the present disclosure;

FIG. 2 is a block diagram of a device for managing an update of an ECU of a vehicle according to an embodiment of the present disclosure;

FIG. 3 is a flowchart of a method for managing an update of an ECU of a vehicle according to an embodiment of the present disclosure; and

FIG. 4 is a block diagram illustrating a computing system for executing a method for managing an update of an ECU of a vehicle according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

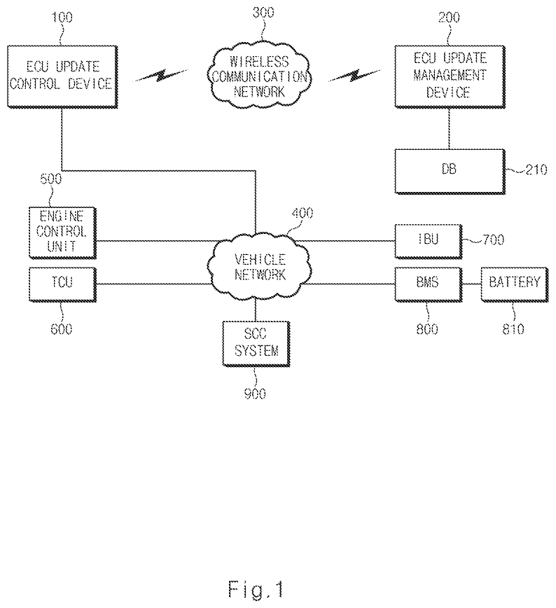

FIG. 1 is an exemplary diagram of a system for managing an update of an electronic control unit (ECU) of a vehicle according to an embodiment of the present disclosure.

As shown in FIG. 1, a system for managing an update of an ECU of a vehicle according to an embodiment of the present disclosure may include an ECU update control device 100, an ECU update management device 200, a wireless communication network 300, a vehicle network 400, an engine control unit 500, a transmission control unit (TCU) 600, an integrated body control unit (IBU) 700, a battery management system (BMS) 800, a smart cruise control (SCC) system 900, and the like.

The ECU update control device 100 may be included in the vehicle, and may control an over the air (OTA) update process of each ECU included in the vehicle in association with the ECU update management device 200 through the wireless communication network 300.

The ECU update control device 100 may collect an ID and version information of software installed in each ECU of the vehicle through the vehicle network 400. As an example, the ECU update control device 100 may collect an ID and version information of at least one software installed in the IBU 600 through diagnostic communication with the IBU 600.

The ECU update control device 100 may transmit the ID of the software installed in each ECU of the vehicle and the version information of the installed software to the ECU update management device 200 through the wireless communication network 300.

The ECU update control device 100 may download update data (for example, firmware data) of each ECU corresponding to version information of the vehicle from the ECU update management device 200. In this connection, the version information of the vehicle will be described in detail in [Table 1] below.

The ECU update control device 100 may sequentially control an update of the software of each ECU by sequentially transmitting the update data of each ECU downloaded from the ECU update management device 200 to the corresponding ECU.

When it is determined by the ECU update management device 200 that the update is impossible, the ECU update control device 100 may display a breakdown code through a display and provide guidance information on a breakdown to a user.

The ECU update control device 100 may detect a success or a failure of the update of each ECU.

When an update of one ECU fails in the process of updating each ECU based on the vehicle version, the ECU update control device 100 may perform rollback of returning a software version of an ECU, which has already been updated, to a previous version.

In one example, the ECU update management device 200 may be implemented as an OTA server as an example, may include an update table in which the ID and the version information of the software corresponding to each ECU of the vehicle are recorded for each version of the vehicle, and manage the update of each ECU of the vehicle based on the update table.

The ECU update management device 200 may manage update data corresponding to an ID and version information of the software stored in a Database (DB) 210. In this connection, the ECU update management device 200 may store the update data corresponding to the ID and the version information of the software in the DB 210.

The ECU update management device 200 may communicate with the ECU update control device 100 through the wireless communication network 300. Such ECU update management device 200 may transmit the update table in which the ID and the version information of the software installed in each ECU of the vehicle are recorded for each version of the vehicle to the ECU update control device 100. In addition, the ECU update management device 200 may transmit the update data of each ECU included in the vehicle to the ECU update control device 100.

The wireless communication network 300 may include a mobile communication network, a wireless Internet, a short range communication network, and the like.

The vehicle network 400 may include a controller area network (CAN), a controller area network with flexible data-rate (CAN FD), a local interconnect network (LIN), a FlexRay, a media oriented systems transport (MOST), an Ethernet, and the like.

The engine control unit 500 may be connected to the vehicle network 400 and may perform overall control of an engine equipped in the vehicle. Such an engine control unit 500 may be replaced with a vehicle control unit (VCU) in an electric vehicle, and may be replaced with a fuel cell control unit (FCU) in a fuel cell vehicle.

The TCU 600 may be connected to the vehicle network 400 and may perform overall control of a transmission equipped in the vehicle.

The IBU 700, which is an ECU incorporating a body control unit (BCM), a smart key system (SKS), and a tire pressure monitoring system (TPMS), may integrally control electronic products of a vehicle body in communication with individual ECUs that control a wiper, a headlamp, a power seat, and the like. Such IBU 700 may start the vehicle or turn off the vehicle. In this connection, the BCM may have rear curtain control, vehicle lock control, exterior lamp control, wiper/washer control functions as convenience functions, and may have vehicle alert state control, mobile telematics system (MTS)-related alarm control, front and rear parking assist control, and seat belt or door opening-based warning control functions as safety functions. The SKS may recognize a smart key to lock/unlock the vehicle with a push button of a door handle, open a trunk, generate a warning based on a location of the smart key, and allow the vehicle to be started with a start button located next to a steering wheel when the smart key is inside the vehicle. The TPMS may monitor an air pressure of a tire based on a tire pressure sensor (TPS) mounted on each wheel of the vehicle.

The BMS 800 may perform overall control of a battery 810 that supplies power to an electric load of the vehicle. Such BMS 800 may manage a SOC of the battery 810, and may provide SOC information of the battery 810 to the ECU update control device 100 of the vehicle through the vehicle network 400. In addition, the BMS 800 may control charging of the battery 810 in a start-on state of the vehicle.

The SCC system 900 may provide speed information of the vehicle through the vehicle network 400 to the ECU update control device 100.

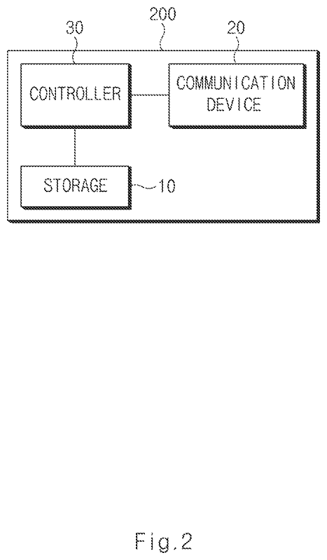

FIG. 2 is a block diagram of a device for managing an update of an ECU of a vehicle according to an embodiment of the present disclosure.

As shown in FIG. 2, the ECU update management device 200 of the vehicle according to an embodiment of the present disclosure may include storage 10, a communication device 20, and a controller 30. In this connection, components may be combined with each other to be implemented as one component, or some components may be omitted based on a scheme for implementing the ECU update management device 200 of the vehicle according to an embodiment of the present disclosure.

Looking at each of the components, first, the storage 10 may include the update table in which the ID and the version information of the software corresponding to each ECU of the vehicle are recorded for each version of the vehicle, and store various logics, algorithms, and programs required in the process of managing the update for each ECU of the vehicle. As an example, the update table is shown in Table 1 below.

TABLE 1

| Version | | | | | |
|---|---|---|---|---|---|
| of | Software version | | | | |
| vehicle | H1S1 | H2S1 | H3S1 | H3S2 | H4S1 |
| 2.04 | 4 | 4 | 4 | 4 | 4 |
| 2.03 | 4 | 4 | 4 | 3 | 4 |
| 2.02 | 4 | 4 | 3 | 3 | 3 |
| 2.01 | 3 | 3 | 3 | 2 | 2 |
| 2.00 | 2 | 3 | 3 | 2 | 1 |
| 1.02 | 2 | 2 | 2 | 2 | 1 |
| 1.01 | 1 | 2 | 1 | 1 | 1 |
| 1.00 | 1 | 1 | 1 | 1 | 1 |

As being able to be seen from [Table 1], versions of all software in the vehicle in the lowest version 1.00 of the vehicle is an initial version 1, and versions of all software in the vehicle in the latest version 2.04 of the vehicle is the latest version 4.

In this connection, H1 represents an ID of an ECU 1, H2 represents an ID of an ECU 2, H3 represents an ID of an ECU 3, and H4 represents an ID of an ECU 4. In addition, S1 represents an ID of software 1 and S2 represents an ID of software 2.

Therefore, H1S1 means the software 1 of the ECU 1, H2S1 means the software 1 of the ECU 2, H3S1 means the software 1 of the ECU 3, H3S2 means the software 2 of the ECU 3, and H4S1 means the software 1 of the ECU 4.

As an example, when the version of the vehicle is 2.00, a version of the software 1 corresponding to ECU 1 (the H1S1) is 2, a version of the software 1 of the ECU 2 (the H2S1) is 3, a version of the software 1 of the ECU 3 (the H3S1) is 3, a version of the software 2 of the ECU 3 (the H3S2) is 2, and a version of the software 1 of the ECU 4 (the H4S1) is 1.

Such update table may contain software version information different from that of [Table 1] based on at least one of a vehicle type, a region, and a vehicle identification number.

The storage 10 may include at least one type of recording media (storage media) of a memory of a flash memory type, a hard disk type, a micro type, a card type (e.g., a secure digital card (SD card) or an eXtream digital card (XD card)), and the like, and a memory of a random access memory (RAM), a static RAM (SRAM), a read-only memory (ROM), a programmable ROM (PROM), an electrically erasable PROM (EEPROM), a magnetic RAM (MRAM), a magnetic disk, and an optical disk type.

The communication device 20 may receive the ID and the version information of the software installed in each ECU of the vehicle from the ECU update control device 100. That is, the communication device 20 may request the update to the ECU update control device 100.

The communication device 20, which is a module that provides an interface for communication with the ECU update control device 100, may transmit the update data (for example, the firmware data) corresponding to each ECU of the vehicle to the ECU update control device 100.

The communication device 20 may transmit, to the ECU update control device 100, the update table in which the ID and the version information of the software corresponding to each ECU of the vehicle are recorded for each version of the vehicle.

The communication device 20 may transmit, to the ECU update control device 100, the information indicating that the update is impossible (or that version up of the vehicle is impossible) under control of the controller 30.

Such communication device 20 may include at least one of a mobile communication module, a wireless Internet module, or a short-range communication module.

The mobile communication module may receive the update data through a mobile communication network built based on technical standards or communication schemes for mobile communication (e.g., a global system for mobile communication (GSM)), a code division multi access (CDMA), a code division multi access 2000 (CDMA2000), an enhanced voice-data optimized or enhanced voice-data only (EV-DO)), a wideband CDMA (WCDMA), a high speed downlink packet access (HSDPA), a high speed uplink packet access (HSUPA), a long term evolution (LTE), a long term evolution-advanced (LTEA), and the like).

The wireless Internet module, which is a module for wireless Internet access, may receive the update data through a wireless LAN (WLAN), a wireless-fidelity (Wi-Fi), a wireless fidelity (Wi-Fi) Direct, a digital living network alliance (DLNA), a wireless broadband (WiBro), a world interoperability for microwave access (WiMAX), a high speed downlink packet access (HSDPA), a high speed uplink packet access (HSUPA), a long term evolution (LTE), a long term evolution-advanced (LTE-A), and the like.

The short-range communication module may support short-range communication using at least one of technologies of a Bluetooth, a radio frequency identification (RFID), an infrared data association (IrDA), an ultra wideband (UWB), a ZigBee, a near field communication (NFC), or a wireless universal serial bus (Wireless USB).

The controller 30 performs overall control such that the respective components are able to normally perform functions thereof. Such controller 30 may be implemented in a form of hardware, may be implemented in a form of software, or may be implemented in a form in which the hardware and the software are combined with each other. The controller 30 may be implemented as a microprocessor, but may not be limited thereto.

In particular, the controller 30 may include the update table in which the ID and the version information of the software corresponding to each ECU of the vehicle are recorded for each version of the vehicle, and may perform various control in the process of managing the update for each ECU of the vehicle based on the update table.

Hereinafter, the operation of the controller 30 will be described in detail with reference to [Table 1].

As an example, when the H1S1 receives 1, the H2S1 receives 1, the H3S1 receives 2, the H3S2 receives 2, and the H4S1 receives 1 as the software version information from the ECU update control device 100, such combination is not mentioned in [Table 1], but all of the software version information is included in a lower version group among the versions of the vehicle, so that the controller 30 may determine that version up to a higher version group is possible. In this connection, the lower version group, which is a group of versions whose first digit is 1 among the versions of the vehicle, may include 1.00, 1.01, and 1.02, and the higher version group, which is a group of versions whose first digit is 2 among the versions of the vehicle, may include 2.00, 2.01, 2.02, 2.03, and 2.04.

When version up to 2.00 is possible as such, the controller 30 may provide data for updating the H1S1 to 2, data for updating the H2S1 to 3, and data for updating the H3S1 to 3 to the ECU update control device 100.

In the case of the version up from the lower version group to the higher version group, it is preferable that the controller 30 performs the version up to 2.00 first, and additionally performs version up to 2.04 later, but is not limited thereto.

As another example, when the H1S1 receives 1, the H2S1 receives 3, the H3S1 receives 1, the H3S2 receives 1, and the H4S1 receives 1 as the software version information from the ECU update control device 100, such combination is not mentioned in [Table 1], and not all of the software version information is included in the lower version group among the versions of the vehicle. That is, the version of the H2S1 is 3, and is included in the higher version group in which the vehicle version is 2.00. Accordingly, the controller 30 may determine that the update is impossible (or the version up of the vehicle is impossible).

When it is determined that the update is impossible, the controller 30 may inform the ECU update control device 100 that the update is impossible.

As another example, when the H1S1 receives 1, the H2S1 receives 1, the H3S1 receives 1, the H3S2 receives 1, and the H4S1 receives 1 as the software version information from the ECU update control device 100, such combination corresponds to the case in which the version of the vehicle is 1.00, so that the version up to 2.00 of the higher version group is possible. Accordingly, the controller 30 may provide the data for updating the H1S1 to 2, the data for updating the H2S1 to 3, the data for updating the H3S1 to 3, and data for updating the H3S2 to 2 to the ECU update control device 100.

As another example, when the H1S1 receives 2, the H2S1 receives 3, the H3S1 receives 3, the H3S2 receives 2, and the H4S1 receives 1 as the software version information from the ECU update control device 100, such combination corresponds to the case in which the vehicle version is 2.00, so that version up to 2.04, which is the latest version, is possible. Accordingly, the controller 30 may provide data for updating the H1S1 to 4, data for updating the H2S1 to 4, data for updating the H3S1 to 4, data for updating the H3S2 to 4, and data for updating the H4S1 to 4 to the ECU update control device 100.

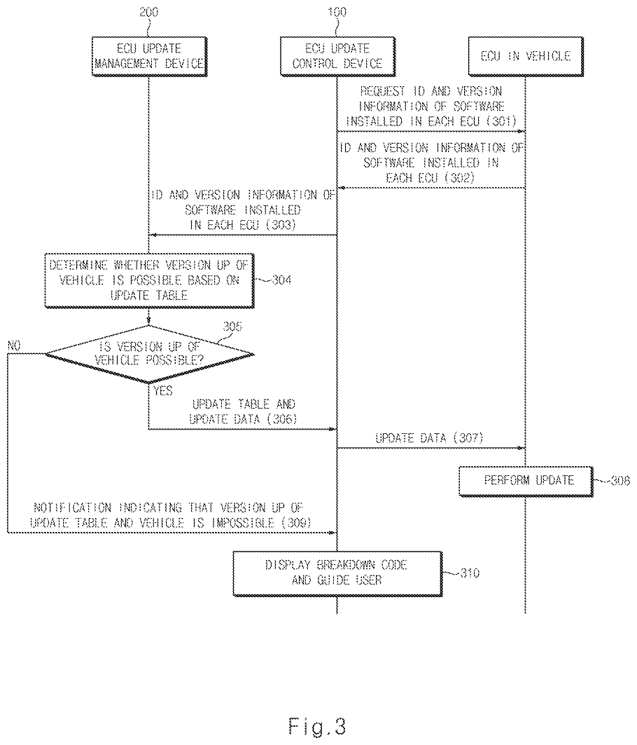

FIG. 3 is a flowchart of a method for managing an update of an ECU of a vehicle according to an embodiment of the present disclosure.

First, the ECU update control device 100 may collect the ID and the version information of at least one software installed in each ECU through the diagnostic communication with each ECU included in the vehicle (301 and 302).

Thereafter, the ECU update control device 100 may transmit the ID and the version information of the software installed in each ECU of the vehicle to the ECU update management device 200 (303).

Thereafter, the ECU update management device 200 may determine whether the version up of the vehicle is possible based on the update table as shown in [Table 1], and the ID and the version information of the software installed in each ECU received from the ECU update control device 100 (304).

When the version up of the vehicle is possible as the determination result 304, the update table and the update data may be transmitted to the ECU update control device 100 (305 and 306). Then, the ECU update control device 100 may transmit the update data to the ECU in the vehicle (307).

When the version up of the vehicle is impossible as the determination result 304, the update table and a notification indicating that the version up of the vehicle is impossible may be transmitted to the ECU update control device 100 (305 and 309). Then, the ECU update control device 100 may display the breakdown code and provide the guidance information on the breakdown to the user.

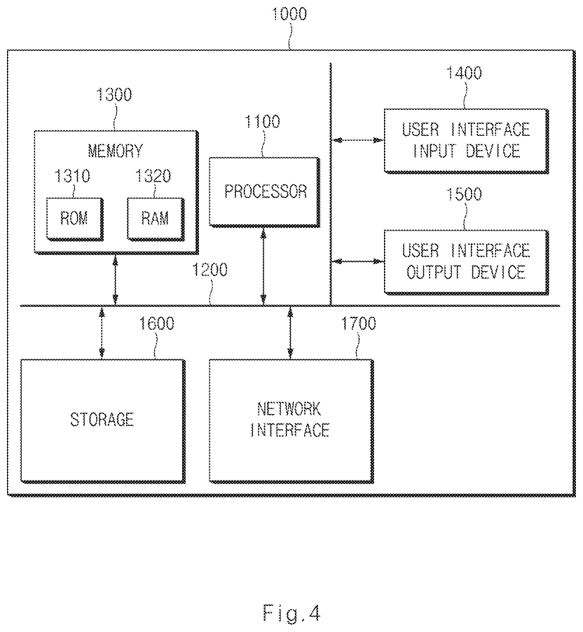

FIG. 4 is a block diagram illustrating a computing system for executing a method for managing an update of an ECU of a vehicle according to an embodiment of the present disclosure.

Referring to FIG. 4, the method for managing the update of the ECU of the vehicle according to an embodiment of the present disclosure described above may also be implemented through a computing system. A computing system 1000 may include at least one processor 1100, a memory 1300, a user interface input device 1400, a user interface output device 1500, storage 1600, and a network interface 1700 connected via a bus 1200.

The processor 1100 may be a central processing unit (CPU) or a semiconductor device that performs processing on commands stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a solid state drive (SSD), a removable disk, and a CD-ROM. The exemplary storage medium is coupled to the processor 1100, which may read information from, and write information to, the storage medium. In another method, the storage medium may be integral with the processor 1100. The processor and the storage medium may reside within an application specific integrated circuit (ASIC). The ASIC may reside within the user terminal. In another method, the processor and the storage medium may reside as individual components in the user terminal.

The description above is merely illustrative of the technical idea of the present disclosure, and various modifications and changes may be made by those skilled in the art without departing from the essential characteristics of the present disclosure.

Therefore, the embodiments disclosed in the present disclosure are not intended to limit the technical idea of the present disclosure but to illustrate the present disclosure, and the scope of the technical idea of the present disclosure is not limited by the embodiments. The scope of the present disclosure should be construed as being covered by the scope of the appended claims, and all technical ideas falling within the scope of the claims should be construed as being included in the scope of the present disclosure.

The device and the method for managing the update of the ECU of the vehicle according to an embodiment of the present disclosure as described above enable the batch updates of the ECUs included in the vehicle by including the update table in which the ID and the version information of the software corresponding to each ECU of the vehicle are recorded for each version of the vehicle, and managing the update for each ECU of the vehicle based on the update table.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A device for managing an update of an electronic control unit (ECU) of a vehicle, the device comprising:
storage configured to store an update table, wherein an identification (ID) and version information of software corresponding to each of a plurality of ECUs of the vehicle are recorded for each version of the vehicle in the update table;
a communication device configured to receive the ID and the version information of the software installed in each of the plurality of ECUs; and
a controller configured to manage an update for each of the plurality of ECUs based on the update table having the ID and the version information of the software installed in each of the plurality of ECUs.

2. The device of claim 1, wherein the controller is configured to:
divide versions of the software respectively installed in the plurality of ECUs into a lower version group and a higher version group, and
determine that updating a version to the lowest version in the higher version group is possible when all of the version information of the software installed in each of the plurality of ECUs is included in the lower version group.

3. The device of claim 2, wherein the controller is configured to transmit update data corresponding to the lowest version in the higher version group to an ECU update control device.

4. The device of claim 1, wherein the controller is configured to:
divide the versions of the software respectively installed in of the plurality of ECUs into a lower version group and a higher version group, and
determine that the update is impossible when not all of the version information of the software installed in each of the plurality of ECUs is included in the lower version group.

5. The device of claim 4, wherein the controller is configured to inform an ECU update control device upon determining that the update is impossible.

6. The device of claim 1, wherein the update table includes:
a plurality of fields where versions of the software are sequentially recorded; and
a plurality of fields where the version information of each software of each of the plurality of ECUs is recorded corresponding to each of the plurality of fields where the versions of the software are sequentially recorded.

7. A method for managing an update of an electronic control unit (ECU) of a vehicle, the method comprising:
storing, by storage, an update table, wherein an identification (ID) and version information of software corresponding to each of a plurality of ECUs of the vehicle are recorded for each version of the software in the update table;
receiving, by a communication device, the ID and the version information of the software installed in each of the plurality of ECUs of the vehicle; and
managing, by a controller, an update for each of the plurality of ECUs based on the update table having the ID and the version information of the software installed in each of the plurality of ECUs.

8. The method of claim 7, wherein the managing of the update for each of the plurality of ECUs includes:
dividing the versions of the software respectively installed in the plurality of ECUs into a lower version group and a higher version group; and
determining that updating a version to a lowest version in the higher version group is possible in a situation in which all of the version information of the software installed in each of the plurality of ECUs is included in the lower version group.

9. The method of claim 8, wherein the managing of the update for each of the plurality of ECUs further includes transmitting update data corresponding to the lowest version in the higher version group to an ECU update control device.

10. The method of claim 7, wherein the managing of the update for each of the plurality of ECUs includes:
dividing the versions of the software into a lower version group and a higher version group; and
determining that the update is impossible in a situation in which not all of the version information of the software installed in each of the plurality of ECUs is included in the lower version group.

11. The method of claim 10, wherein the managing of the update for each of the plurality of ECUs further includes informing an ECU update control device upon determining that the update is impossible.

12. The method of claim 7, wherein the update table includes:
a plurality of fields where the versions of the software are sequentially recorded; and
a plurality of fields where the version information of each software of each of the plurality of ECUs is recorded corresponding to each of the plurality of fields where the versions of the software are sequentially recorded.

13. A system for managing an update of an electronic control unit (ECU) of a vehicle, the system comprising:
an ECU update management device configured to:
store an update table, wherein an identification (ID) and version information of software corresponding to each of a plurality of ECUs of the vehicle are recorded for each version of the software, respectively, in the update table,
receive the ID and the version information of the software installed in each of the plurality of ECUs, and
manage an update for each of the plurality of ECUs based on the update table having the ID and the version information of the software installed in each ECU; and
an ECU update control device configured to:
transmit the ID and the version information of the software installed in each of the plurality of ECUs to the ECU update management device, and
control the update of each of the plurality of ECUs in association with the ECU update management device.

14. The system of claim 13, wherein the ECU update management device is configured to:
divide the versions of the software of each of the plurality of ECUs into a lower version group and a higher version group, and
determine that version up to a lowest version in the higher version group is possible in a case in which all of the version information of the software installed in each of the plurality of ECUs is included in the lower version group.

15. The system of claim 14, wherein the ECU update management device is configured to transmit update data corresponding to the lowest version in the higher version group to the ECU update control device.

16. The system of claim 15, wherein the ECU update control device is configured to perform roll back of returning a version of an ECU that has already been updated to a previous version in a process of controlling the update of each ECU of the vehicle when an update of one ECU has failed.

17. The system of claim 13, wherein the ECU update management device is configured to:
divide the versions of the software installed in each of the plurality of ECUs into a lower version group and a higher version group, and
determine that the update is impossible when not all of the version information of the software installed in each of the plurality of ECUs is included in the lower version group.

18. The system of claim 17, wherein the ECU update management device is configured to inform the ECU update control device upon determining that the update is impossible.

19. The system of claim 18, wherein the ECU update control device is configured to:
display a breakdown code upon determined by the ECU update management device that the update is impossible, and
provide guidance information on a breakdown to a user.

20. The system of claim 13, wherein the update table includes:
a plurality of fields where the versions of the vehicle are sequentially recorded; and
a plurality of fields where the version information of each software of each of the plurality of ECUs is recorded corresponding to each of the plurality of fields, respectively, where the versions of the vehicle are sequentially recorded.
